(19) United States
(12) Patent Application Publication
(10) Pub. No.: US 2019/0208533 A1
(43) Pub. Date: Jul. 4, 2019

(54) Transmission and Reception Slot Management Apparatus and Method for Maritime Communication and VHF Data Exchange System for Ship

(71) Applicants: Ju Hwan Lee, Seoul (KR); Hyung Jin Moon, Gunpo-si (KR)

(72) Inventors: Ju Hwan Lee, Seoul (KR); Hyung Jin Moon, Gunpo-si (KR)

(21) Appl. No.: 16/210,947

(22) Filed: Dec. 5, 2018

(30) Foreign Application Priority Data
Dec. 8, 2017 (KR) 10-2017-0168571

(51) Int. Cl. H04W 72/12

(52) U.S. Cl. CPC H04W 72/1242; H04B 1/3822

(57) ABSTRACT

Provided are a transmission/reception slot management apparatus and method for maritime communication and a VHF data exchange system for a ship. The transmission/reception slot management method performed by a transmission/reception slot management apparatus of a VHF data exchange system (VDES) for a ship, the transmission/reception slot management method includes allocating, to a slot map for transmitting and receiving data through a single antenna for transmission/reception, a reception slot according to slot reservation information received from another ship station or a base station (BS), sorting transmission data to be transmitted to the other ship station or the BS according to a predetermined priority, and sequentially allocating, to the slot map, the sorted transmission data according to the predetermined priority.

### CROSS-REFERENCE TO RELATED APPLICATIONS

This application claims benefit of priority to Korean Patent Application No. 10-2017-0168571 filed on 8 Dec. 2017 in the Korean Intellectual Property Office, the disclosure of which is incorporated herein by reference in its entirety.

### BACKGROUND

### 1. Technical Field

The present invention relates to maritime communication, and more particularly, to a transmission and reception slot management apparatus and method for maritime communication and VHF data exchange system for a ship.

### 2. Description of related art

The related art automatic identification system (AIS) for maritime communication selects one of two channels designated with a 25 KHz bandwidth to transmit 256-bit data at a fixed transfer rate of 9.6 Kbps. Here, the AIS is configured to transmit data using one slot resource divided into 2,250 26.667 ms using 1 minute as one frame. Exceptionally, application messages having a lower priority such as messages #6 (addressed binary message), #8 (binary broadcast message), and #26 (multi-slot binary message with communications state) (which have 4th priority), among 27 types of messages of the AIS, require one or more slots. The AIS is defined to transmit data using up to five consecutive slots (See ITU-R M.1371-5 3.2.2.11).

Table 1 below shows a configuration of message #6 among the application messages.

TABLE 1

| Parameter | Number of bits | Description |
|---|---|---|
| Message ID | 6 | Identifier for Message 6; always 6 |
| Repeat indicator | 2 | Used by the repeater to indicate how many times a message has |
| | | been repeated. See § 4.6.1, Annex 2; 0-3; 0 = default; |
| | | 3 = do not repeat any more |
| Source ID | 30 | MMSI number of source station |
| Sequence number | 2 | 0-3; see § 5.3.1, Annex 2 |
| Destination ID | 30 | MMSI number of destination station |
| Retransmit flag | 1 | Retransmit flag should be set upon retransmission: 0 = no |
| | | retransmission = default; 1 = retransmitted |
| Spare | 1 | Not used. Should be zero |
| DAC | 10 | International DAC = 1₁₀ = 0000000001₂ |
| FI | 6 | Function identifier = 0₁₀ = 000000₂ |
| Acknowledge | 1 | 1 = reply is required, optional for addressed binary messages and |
| required flag | | not used for binary broadcast messages |
| | | 0 = reply is not required, optional for an addressed binary message |
| | | and required for binary broadcast messages |
| Text sequence | 11 | Sequence number to be incremented by the application. |
| number | | All zeros indicates that sequence numbers are not being used |
| Text string | 6-906 | 6-bit ASCII as defined in Table 47, Annex 8. When using this IFM, |
| | | the number of slots used for transmission should be minimized |
| | | taking into account Table 29. |
| | | For Message 6 the maximum is 906. |
| Spare bits | Max 6 | Not used for data and should be set to zero. The number of bits |
| | | should be either 0, 2, 4, or 6 to maintain byte boundaries. |
| | | NOTE 1 - When a 6-bit spare is needed to satisfy the 8-bit byte |
| | | boundary rule, the 6-bit spare will be interpreted as a valid 6-bit |
| | | character (all zeros is the “@” character). This is the case when the |
| | | number of characters is: 1, 5, 9, 13, 17, 21, 25, etc. |
| Total number of | 112-1 008 | For Message 6 the maximum is 920. |
| application | | |
| data bits | | |

However, this priority is applied to both a received message and a message to be transmitted but it is limited to a transport layer transmitted or received by a presentation interface (PI). A priority of a message sent by another ship does not affect transmission of an application message of an own ship. Thus, when the amount of the application messages used increases, slot resources to be used by essential messages having high priority, such as message #1 (position report—scheduled position report), message #2 (position report—assigned scheduled position report), message #3 (position report—special position report) (messages #1, #2, and #3 have a first priority) is insufficient. This may cause a communication traffic overload problem. In addition, when the available slot resources are not sufficient, a slot collision may frequently occur according to access schemes. Data transmission of essential messages may be delayed due to repeated occupation of multiple slots through slot allocation retry.

As a countermeasure against the problem, the International Maritime Organization (IMO) allocates a dedicated application specific message (ASM) channel for processing a low-priority message requiring multi-slots, such as an ASM message to provide a service.

In order to provide a higher level of maritime communication services, the IMO designated 16 maritime service portfolios (MSPs) as essential services and establishes ground and satellite VHF data exchange (VDE) channels including duplex channels to process the 16 MSPs. These AIS, ASM, and VDE are termed VHF data exchange system (VDES) and international conventions are underway to establish relevant regulations.

Among them, VDE allows large data packets, which is not supported by the existing AIS, such as a video service, to be transmitted in a high bandwidth at a high speed. To this end, VDE features that it allows for transmission up to 307.2 Kb per second in a bandwidth of up to four channels of 100 KHz selectively through a multi-level modulation scheme such as QPSK, 8 PSK, 16 QAM, and the like.

VDE may use channel resources allocated from a base station or a satellite to transmit these large data packets. However, channel resource allocation information is included in an announcement message of the base station called a bulletin board, and this base station announcement message is generated at the beginning of each frame. In addition, it is stipulated that frequencies and slots are designated and used within available channel resources and this information is propagated to neighboring ships through a notification message of the base station called announcement.

### SUMMARY

A newly introduced VHF data exchange system (VDES) is expected to be developed as a next-generation automatic identification system (AIS) integrating the conventional AIS, the application specific message (ASM) and/or the VHF data exchange (VDE). However, in order to solve the following problems, there is a very high demand for introducing a VDES system equipped with a single antenna. For example, in the case of a ship, a space for installing an antenna is insufficient. In addition, several antennas are already installed on the ship and interference between the antennas may occur.

Accordingly, in the case of maritime communication for ships, demand for the VDES system integrating AIS, ASM, and/or VDE to use a single antenna in order to minimize communication interference with a conventional communication system is on the increase. In such a maritime communication system equipped with a single antenna, there is only one transmission antenna, while there are three systems for transmission such as AIS, ASM and VDE, and thus, slots for transmission must be managed. If not, a transmission slot collision may not be prevented. Also, since the maritime communication system cannot receive important information from another ship station or a neighboring base station in the case of transmission, transmission must not be performed during a time period corresponding thereto.

Embodiments of the present invention provide a transmission/reception slot management apparatus and method for maritime communication capable of effectively managing slots for transmitting/receiving AIS, ASM, and/or VDE data in a VHF data exchange system (VDES) for a ship using a single antenna, and a VDES for a ship.

In an aspect, a transmission/reception slot management apparatus used for a VHF data exchange system (VDES) for a ship includes: a slot integrated management unit managing a slot map for transmitting and receiving data through a single antenna for transmission/reception; a plurality of transmission slot management units allocating, to the slot map, a reception slot according to a slot reservation information received from another ship station or a base station (BS); and a data transmission controller sorting transmission data to be transmitted to the other ship station or the base station (BS) according to predetermined priority, wherein the plurality of transmission slot management units sequentially allocate, to the slot map, the sorted transmission data according to the predetermined priority.

The plurality of transmission slot management unit may include: an automatic identification system (AIS) transmission slot management unit allocating, to the slot map, an

AIS transmission slot for transmitting an AIS message among the sorted transmission data; an application specific message (ASM) transmission slot management unit allocating, to the slot map, an ASM transmission slot for transmitting an application specific message (ASM) data among the sorted transmission data; and a VHF data exchange (VDE) transmission slot management unit allocating, to the slot map, a VDE transmission slot for transmitting VDE data among the sorted transmission data, wherein after reception slots according to slot reservation information received from another ship station or a BS are each allocated to the slot map, the AIS transmission slot, the ASM transmission slot, and the VDE transmission slot are allocated to the slot map, and the AIS transmission slot management unit may first allocate, to the slot map, an AIS transmission slot for transmitting a position message of an own ship before any other AIS transmission slots.

The plurality of transmission slot management units may each allocate a reception slot according to each slot reservation information for receiving an AIS message, ASM data, and VDE data from the other ship station or the base station(BS).

The data transmission controller may sort the transmission data in order of an AIS message, ASM data, and VDE data.

The plurality of transmission slot management units may first allocate an AIS transmission slot for transmitting a safety message related to ship safety among the transmission data before the other AIS transmission slots excluding an AIS transmission slot for transmitting a position message.

The plurality of transmission slot management units may allocate an AIS transmission slot to an empty slot in which a collision does not occur with the reception slot in the slot map to which the reception slot has been allocated.

The plurality of transmission slot management units may allocate an ASM transmission slot to an empty slot in which a collision does not occur with previously allocated slots in the slot map to which the reception slot and the AIS transmission slot have been allocated.

The plurality of transmission slot management units may allocate a VDE transmission slot to an empty slot in which a collision does not occur with previously allocated slots in the slot map to which the reception slot, the AIS transmission slot, and the ASM transmission slot have been allocated.

In another aspect, a transmission/reception slot management method performed by a transmission/reception slot management apparatus of a VHF data exchange system (VDES) for a ship includes: allocating, to a slot map for transmitting and receiving data through a single antenna for transmission/reception, a reception slot according to slot reservation information received from another ship station or a base station(BS); sorting transmission data to be transmitted to the other ship station or the base station(BS) according to a predetermined priority; and sequentially allocating, to the slot map, the sorted transmission data according to the predetermined priority.

The sequentially allocating of the sorted transmission data may include: allocating, to the slot map, an AIS transmission slot for transmitting automatic identification system (AIS) data among the sorted transmission data; allocating, to the slot map, an ASM transmission slot for transmitting an application specific message (ASM) data among the sorted transmission data; and allocating, to the slot map, a VHF data exchange (VDE) transmission slot for transmitting VDE data among the sorted transmission data, wherein, in the allocating of the AIS transmission slot, an AIS transmission slot for transmitting a position message of an own ship may be first allocated to the slot map before any other AIS transmission slots.

In the allocating of a reception slot, the reception slot may be allocated according to each slot reservation information for receiving an AIS message, ASM data, and VDE data from the other ship station or the BS.

In the sorting of transmission data, the transmission data may be sorted in order of an AIS message, ASM data, and VDE data.

In the sequentially allocating of the sorted transmission data, an AIS transmission slot for transmitting a safety message related to ship safety among the transmission data may be first allocated before the other AIS transmission slots excluding an AIS transmission slot for transmitting a position message.

In the sequentially allocating of the sorted transmission data, an AIS transmission slot may be allocated to an empty slot in which a collision does not occur with the reception slot in the slot map to which the reception slot has been allocated.

In the sequentially allocating of the sorted transmission data, an ASM transmission slot may be allocated to an empty slot in which a collision does not occur with previously allocated slots in the slot map to which the reception slot and the AIS transmission slot have been allocated.

In the sequentially allocating of the sorted transmission data, a VDE transmission slot may be allocated to an empty slot in which a collision does not occur with previously allocated slots in the slot map to which the reception slot, the AIS transmission slot, and the ASM transmission slot have been allocated.

In another aspect, a VHF data exchange system (VDES) for a ship, the VHF data exchange system(VDES) includes: a single antenna for transmission/reception for transmitting and receiving a communication signal to and from another ship station or a base station (BS); a switch switching a path of the single antenna for transmission/reception to a transmitter or a receiver; a transmitter transmitting data via the single antenna for transmission/reception; a receiver receiving data via the single antenna for transmission/reception; and a processor managing a slot map for transmitting and receiving data via the single antenna for transmission/reception and controlling the transmitter and the receiver on the basis of the slot map, wherein the processor allocates a reception slot according to slot reservation information received through the receiver, sorts transmission data to be transmitted to another ship or a base station(BS) according to a predetermined priority, and sequentially allocates, to the slot map, the sorted transmission data according to the predetermined priority.

The processor may sequentially allocate, to the slot map, an AIS transmission slot for transmitting an AIS message, an ASM transmission slot for transmitting ASM data, and a VDE transmission slot for transmitting VDE data among the sorted transmission data, and here, the processor may first allocate an AIS transmission slot for transmitting a position information of an own ship before any other AIS transmission slots.

The VHF data exchange system may further include: a filter extracting a channel signal of at least one of an AIS channel signal, an ASM channel signal, and a VDE channel signal through filtering of a signal received through the switch, and delivering the extracted channel signal to the receiver; and a global positioning system (GPS) receiver receiving a global positioning system(GPS) signal through a global positioning system(GPS) antenna and delivering the received global positioning system(GPS) signal to the processor.

### BRIEF DESCRIPTION OF THE DRAWINGS

FIG. 1 is a block diagram of a very high frequency (VHF) data exchange system for a ship according to an embodiment of the present invention.

FIG. 2 is a block diagram of a transmission/reception slot management apparatus of a VHF data exchange system for a ship according to an embodiment of the present invention.

FIG. 3 is a diagram illustrating a usage state of a reception slot and a transmission slot in a slot map according to an embodiment of the present invention.

FIG. 4 is a flowchart illustrating a transmission/reception slot management method performed by a transmission/reception slot management apparatus in a VHF data exchange system for a ship according to an embodiment of the present invention.

FIG. 5 is a flowchart illustrating a process of reserving a reception slot using slot reservation information in a transmission/reception slot management method according to an embodiment of the present invention.

FIG. 6 is a flowchart illustrating a process of checking priority of user data and sorting message in a transmission/reception slot management method according to an embodiment of the present invention.

FIG. 7 is a flowchart illustrating a process of allocating a position automatic identification system (AIS) transmission slot in a transmission/reception slot management method according to an embodiment of the present invention.

FIG. 8 is a flowchart illustrating a process of allocating AIS transmission slots #6 and #8 in a transmission/reception slot management method according to an embodiment of the present invention.

FIG. 9 is a flowchart illustrating a process of allocating application specific message (ASM) and VHF data exchange (VDE) transmission slots in a transmission/reception slot management method according to an embodiment of the present invention.

### DETAILED DESCRIPTION OF EXAMPLE EMBODIMENTS OF THE INVENTION

The present invention may be modified variably and may have various embodiments, particular examples of which will be illustrated in drawings and described in detail. However, it is to be understood that the present invention is not limited to a specific disclosed form, but includes all modifications, equivalents, and substitutions without departing from the scope and spirit of the present invention.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present invention. As used here, the term “and/or” includes any and all combinations of one or more of the associated listed items.

It is to be understood that when one element is referred to as being “connected to” or “coupled to” another element, it may be connected directly to or coupled directly to another element or be connected to or coupled to another element, having the other element intervening therebetween. Meanwhile, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to” and the like, should be similarly interpreted.

Terms used in the present specification are used only in order to describe specific embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification, including technical and scientific terms have the same meaning as those that are understood by those skilled in the art to which the present invention pertains. It must be understood that the terms defined by the dictionary are identical with the meanings within the context of the related art, and they should not be ideally or excessively formally defined unless the context clearly dictates otherwise.

Hereinafter, embodiments of the present invention will be described in detail with reference to the accompanying drawings. In describing the present invention, in order to facilitate overall understanding of the present invention, the same reference numerals indicate the same members throughout the accompanying drawings and redundant descriptions of the same components will be omitted.

A base station (BS) of the present invention may include any one of an advanced BS (ABS), an HR-BS, a site controller, a base transceiver system (BTS), an access point (AP), or any other type interfacing device that may operate in a wireless environment, but is not limited thereto.

The BS may be part of a remote area network which may include other BSs such as a base station controller (BSC), a radio network controller (RNC), a relay node, and the like, and/or a network element (not shown). The BS may be configured to transmit and/or receive radio signals in a specific geographical area which may be referred to as a cell (not shown).

The BS may also be referred to as a coast station, a land BS, a satellite BS, or any other terminology.

In case where a VHF data exchange system (VDES) 100 for a ship according to an embodiment of the present invention uses a single antenna for exchanging ship data, the followings must be considered.

First, according to Recommendation ITU-R M.2092, a VHF data exchange system (VDES) standard for ships, priority of communication for data exchange is in order of automatic identification system (AIS) communication, application specific message (ASM) communication, and VDE communication.

The VDES 100 for a ship having a single antenna may simultaneously receive an AIS message, ASM data, and VHF data exchange (VDE) data by applying a filter during a reception period rather than a transmission period.

In addition, when a single antenna is used, reception is impossible during transmission.

Due to the characteristics of the single antenna, it is impossible to transmit ASM data and VDE data during AIS transmission. For example, when ASM data is transmitted, it is impossible to transmit an AIS message and VDE data. In another example, when VDE data is transmitted, it is impossible to transmit an AIS message and ASM data.

For this reason, the VDES 100 for a ship using a single antenna may efficiently transmit each data by performing a transmission slot allocation process using the single antenna.

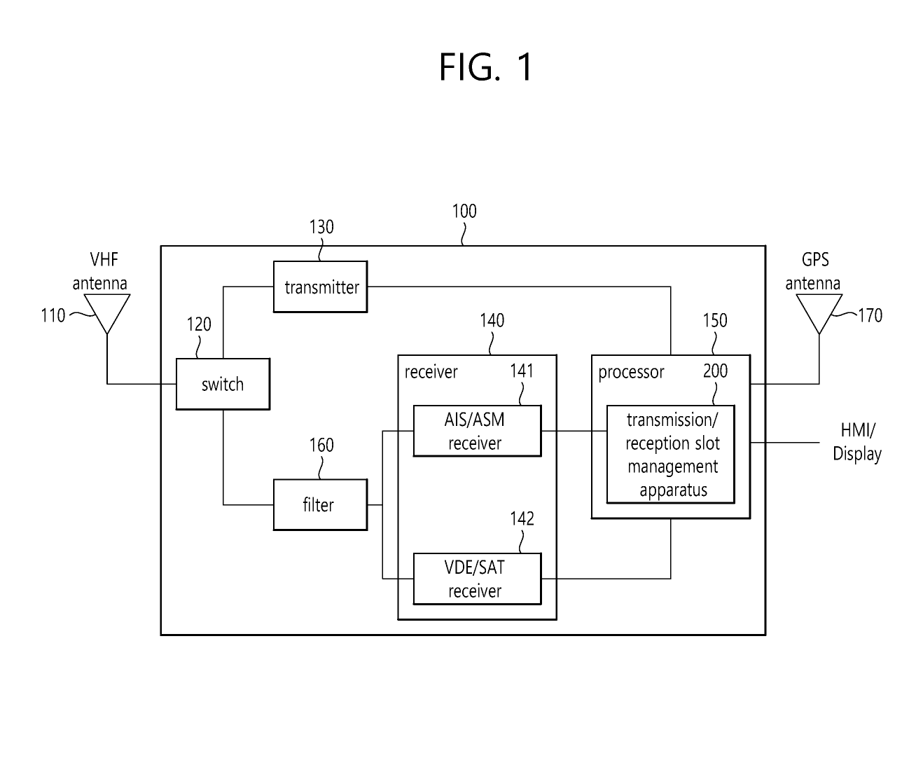

FIG. 1 is a block diagram of a VDES for a ship according to an embodiment of the present invention.

As illustrated in FIG. 1, a VDES 100 for a ship according to an embodiment of the present invention includes a single antenna 110 for transmission/reception, a switch 120, a transmitter 130, a receiver 140, and a processor 150. Here, the VDES 100 for a ship may further include a filter 160 and a global positioning system (GPS) receiver 170.

Hereinafter, a specific configuration and operation of each element of the VDES 100 for a ship according to an embodiment of the present invention of FIG. 1 will be described. Here, for the purposes of description, satellite VDE communication is omitted but other embodiments of the present invention may also include satellite VDE communication.

The single antenna 110 for transmission/reception transmits and receives communication signals to and from another ship station or a BS. The single antenna 110 for transmission/reception may be implemented as a VHF antenna.

The switch 120 switches a path of the single antenna 110 for transmission/reception to the transmitter 130 or the receiver 140. The switch 120 may be realized as a transmit/receive switch (T/R switch). The switch 120 is used for converting a transmission mode and a reception mode.

The transmitter 130 transmits data to another ship station or a BS via the single antenna 110 for transmission/reception. The transmitter 130 may be realized as an AIS-VDE multi-function transmitter. The AIS-VDE multifunctional transmitter converts a baseband signal of each signal (i.e., AIS signal, ASM signal, VDE signal, etc.) into a radio signal according to the characteristics (transmission output, transmission frequency, etc.) required by the system and transmits the same. In addition, the AIS-VDE multifunctional transmitter may selectively transmit any one of the AIS signal, the ASM signal, and the VDE signal.

The receiver 140 receives data through the single antenna 110 for transmission/reception from another ship station or a BS. The receiver 140 includes a 4-channel AIS/ASM receiver 141 and a 2-channel VDE/SAT receiver 142. Each received signal (e.g., AIS signal, ASM signal, VDE signal, SAT signal, etc.) may be converted into a baseband signal. In addition, the receiver 140 may simultaneously or selectively receive the AIS signal, the ASM signal, the VDE signal, and the SAT signal.

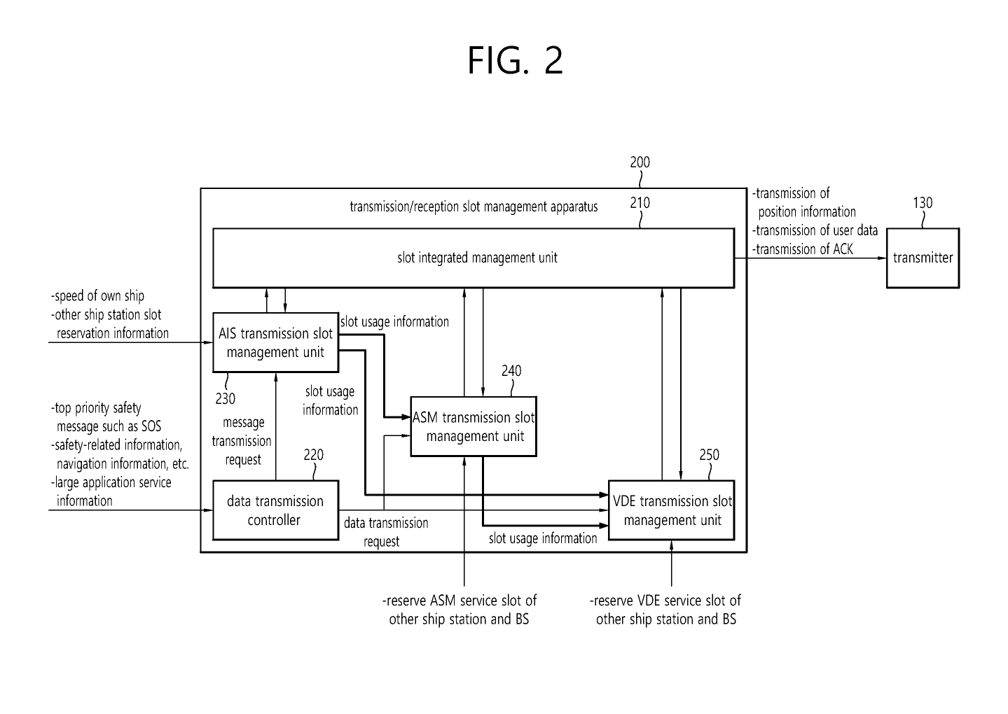

The processor 150 may be realized as a multi-functional Rx/Tx processor. The multifunctional Rx/Tx processor may serve as a controller for controlling and managing the entire VDES 100 for a ship, such as message creation, message analysis, slot map management, and the like. The processor 150 manages a slot map for transmitting and receiving data through the single antenna 110 for transmission/reception through the transmission/reception slot management apparatus 200 and controls the transmitter 130 and the receiver 140 based on the slot map. The transmission/reception slot management apparatus 200 allocating the reception slots and transmission slots according to the slot map and requesting data transmission through the allocated slots is included in the processor 150 of FIG. 1. That is, the processor 150 includes the transmission/reception slot management apparatus 200. The processor 150 may be implemented as an AIS-VDE multi-functional TX/RX processor. The transmission/reception slot management apparatus 200 may be implemented as a sub-device of the AIS-VDE multifunctional Tx/Rx processor. Details thereof will be described with reference to FIG. 2.

Here, the processor 150 allocates a reception slot to the slot map according to slot reservation information received through the receiver 140. The processor 150 sorts transmission data to be transmitted to another ship station or a BS according to a predetermined priority. The processor 150 sequentially allocates an AIS transmission slot for transmitting the AIS message, an ASM transmission slot for transmitting the ASM data, and a VDE transmission slot for transmitting the VDE data, among the sorted transmission data, to the slot map. Here, the processor 150 allocates the AIS transmission slot for transmitting a position message of the own ship to the slot map before other AIS transmission slots.

The filter 160 extracts at least one channel signal from among the AIS channel signal, the ASM channel signal, and the VDE channel signal by filtering the signal received through the switching unit, and transmits the channel signal to the receiver 140. The filter 160 may be implemented as a band pass filter that allows a signal to pass through the 161.800-162.025 MHz band. The filter 160 may allow only a signal of a specific band to pass therethrough and suppress a signal of the other bands. The filter 160 may allow only a signal of a specific band among at least one of the AIS signal, the ASM signal, the VDE signal, and the SAT signal to pass therethrough and suppress a signal of the other bands. For example, the filter 160 may allow only any one signal of a specific band among the AIS signal, the ASM signal, the VDE signal, and the SAT signal, and suppress a signal in the other bands. Alternatively, the filter 160 may be implemented as two or three band pass filters to allow only signal of a specific band of each of at least two or three signals among the AIS signal, the ASM signal, the VDE signal and the SAT signal to pass therethrough and suppress signals of the other bands so that at least two or three signals among the AIS signal, the ASM signal, the VDE signal and the SAT signal may be simultaneously received. Alternatively, the filter 160 may be implemented as separate band pass filters for each of the signals so that the AIS signal, the ASM signal, the VDE signal, and the SAT signal may be simultaneously received.

The GPS receiver 170 receives a GPS signal through a GPS antenna and transmits the GPS signal to the processor 150.

FIG. 2 is a block diagram of a transmission/reception slot management apparatus of a VDES for a ship according to an embodiment of the present invention.

As illustrated in FIG. 2, a transmission/reception slot management apparatus 200 of the VDES 100 for a ship according to an embodiment of the present invention includes a slot integrated management unit 210, a data transmission controller 220, an AIS transmission slot management unit 230, an ASM transmission slot management unit 240, and a VDE transmission slot management unit 250. The AIS transmission slot management unit 230, the ASM transmission slot management unit 240, and the VDE transmission slot management unit 250 will be referred to as a plurality of transmission slot management units.

Hereinafter, a specific configuration and operation of each component of the transmission/reception slot management apparatus 200 of the VDES 100 for a ship according to an embodiment of the present invention of FIG. 2 will be described.

The slot integrated management unit 210 manages a slot map for transmitting and receiving data through the single antenna 110 for transmission/reception. The slot integrated management unit 210 integrally performs a process of allocating a reception slot and a transmission slot by interworking with the AIS transmission slot management unit 230, the ASM transmission slot management unit 240, and the VDE transmission slot management unit 250 and a process of requesting data transmission. The slot integrated management unit 210 transfers each data (e.g., position information, user data, ACK transmission, etc.) received from each of the AIS transmission slot management unit 230, the ASM transmission slot management unit 240, and the VDE transmission slot management unit 250 to the transmitter 130.

The data transmission controller 220 sorts transmission data to be transmitted to another ship station or a BS according to a preset priority. For example, the transmission data may include a top priority safety message such as SOS, safety related information, navigation information, large application service information, and the like. Here, the data transmission controller 220 may sort the transmission data in order of AIS message, ASM data, and VDE data as preset priority. The data transmission controller 220 may manage data that a user (mate) wants to transmit to another ship station or a neighboring BS and may sort each data according to the preset priority. That is, the data transmission controller 220 may sort the data according to data sorting order corresponding to the AIS transmission slot, the ASM transmission slot, and the VDE transmission slot according to the priority to be transmitted. For example, the data may be data based on the national marine electronics association (NMEA) format.

The plurality of transmission slot management units sequentially allocate transmission data sorted according to the preset priority to the slot map. Hereinafter, a transmission slot allocation process will be described in detail.

First, the AIS transmission slot management unit 230 receives slot reservation information of another ship station or a BS for an AIS service. Then, the AIS transmission slot management unit 230 first allocates a reception slot for receiving an AIS message from the other ship station or the BS according to the received slot reservation information. The AIS transmission slot management unit 230 allocates an AIS transmission slot for transmitting an AIS message, among the transmission data sorted by the data transmission controller 220, to the slot map. Here, the AIS transmission slot management unit 230 preferentially allocates an AIS slot for transmitting a position of the own ship using speed information (referred to as speed of the ground (SOG)) of the own ship.

Next, the ASM transmission slot management unit 240 receives slot reservation information of another ship station or a BS for an ASM service. Then, the ASM transmission slot management unit 240 first allocates a reception slot for receiving ASM data from the other ship station or the BS according to the received slot reservation information. The ASM transmission slot management unit 240 allocates an ASM transmission slot for transmitting ASM data, among the transmission data sorted by the data transmission controller 220, to the slot map. Here, with reference to the slot map including information of using slots allocated from the AIS transmission slot management unit 230, the ASM transmission slot management unit 240 searches the slot map for an empty slot. Subsequently, the ASM transmission slot management unit 240 allocates an ASM transmission slot to the empty slot of the slot map. The ASM transmission slot management unit 240 may manage allocation of a VDE transmission slot with reference to the information of using the previously allocated slots in the slot map and the information of using slots previously allocated by the AIS transmission slot management unit 230 and the VDE transmission slot management unit 250.

Thereafter, the VDE transmission slot management unit 250 receives slot reservation information of another ship station or a BS for a VDE service. Then, the VDE transmission slot management unit 250 first allocates a reception slot for receiving VDE data from the other ship station or the BS according to the received slot reservation information. The VDE transmission slot management unit 250 allocates a VDE transmission slot for transmitting VDE data, among the transmission data sorted by the data transmission controller 220, to the slot map. The VDE transmission slot management unit 250 may manage allocation of the VDE transmission slot with reference to the information of using the slots in the slot map and the information of using the slots previously allocated by the AIS transmission slot management unit 230 and the ASM transmission slot management unit 240.

Here, the AIS transmission slot management unit 230, the ASM transmission slot management unit 240, and the VDE transmission slot management unit 250 allocate reception slots according to the slot reservation information received from the other ship station or the BS to the slot map and subsequently allocate the AIS transmission slot, the ASM transmission slot, and the VDE transmission slot, respectively. That is, the AIS transmission slot management unit 230, the ASM transmission slot management unit 240, and the VDE transmission slot management unit 250 may most preferentially allocate the reception slots according to the slot reservation information for receiving the AIS message, the ASM data, and the VDE data from the other ship stations or the BSs, respectively. Also, the AIS transmission slot management unit 230 may first allocate the AIS transmission slot for transmitting the position message of the own ship, before other AIS transmission slots, to the slot map. Thereafter, the AIS transmission slot management unit 230 may first allocate the AIS transmission slot for transmitting a safety message related to safety of the ship, among the transmission data, before other AIS transmission slots excluding the AIS transmission slot for transmitting the position message.

For example, the AIS transmission slot management unit 230 delivers the slot usage information to the ASM transmission slot management unit 240 and the VDE transmission slot management unit 250. Also, the ASM transmission slot management unit 240 delivers the slot usage information to the VDE transmission slot management unit 250. In another example, when the AIS transmission slot management unit 230 delivers the slot usage information to the ASM transmission slot management unit 240, the ASM transmission slot management unit 240 may deliver the slot usage information thereof together with the slot usage information of the AIS transmission slot management unit 230 to the VDE transmission slot management unit 250. In a modification, the AIS transmission slot management unit 230, the ASM transmission slot management unit 240, and the VDE transmission slot management unit 250 each deliver their own slot usage information to the slot integrated management unit 210. The slot integrated management unit 210 may share the respective slot usage information with the AIS transmission slot management unit 230, the ASM transmission slot management unit 240, and the VDE transmission slot management unit 250.

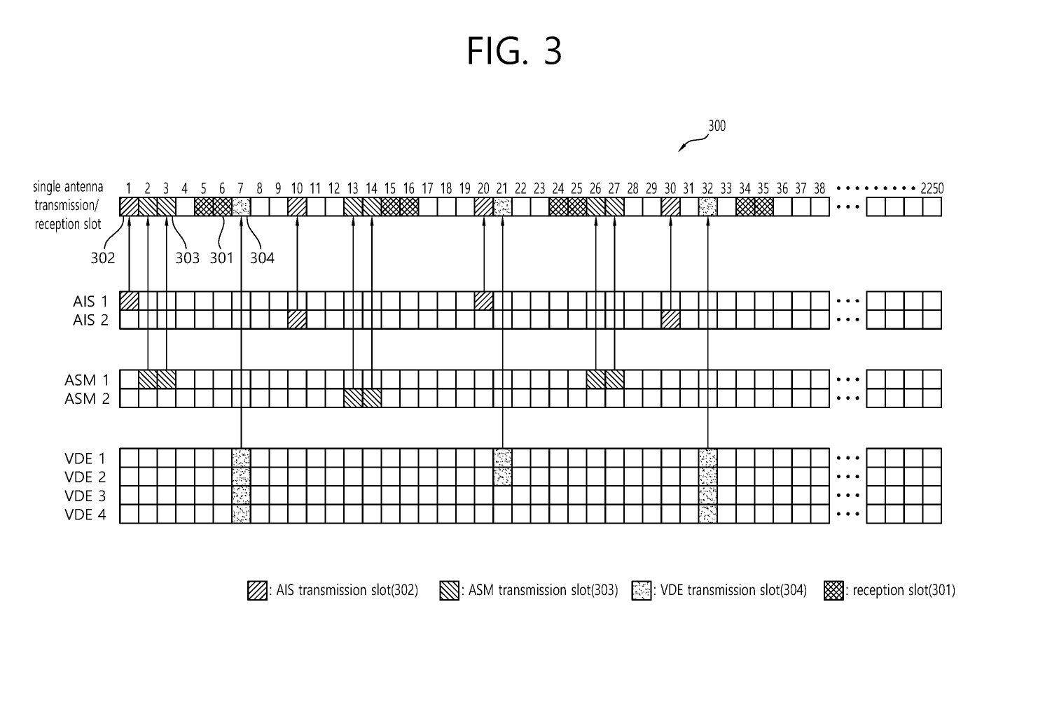

FIG. 3 is a diagram illustrating a usage state of a reception slot and a transmission slot in a slot map according to an embodiment of the present invention.

As illustrated in FIG. 3, the slot map management unit 210 manages the slot map 300 as a memory of an array format. For example, the slot map 300 has a size of 2250 transmission slots per predetermined time (i.e., 1 minute). Here, the size of the slot map 300 may have a memory size of 13500, which is six minutes, in consideration of the memory size of the embedded system. One slot information in the slot map 300 may include information on a transmitting device (e.g., AIS, ASM, VDE), whether a slot has been reserved, and transmission period information.

A process of allocating a transmission slot will be described with reference to the slot map 300 of FIG. 3. In the slot map 300 of FIG. 3, a reception slot 301 is allocated to slots #5, #6, #15, and #16 in advance. The AIS transmission slot management unit 230 may allocate an AIS transmission slot 302 to an empty slot in which no collision occurs with the reception slot 301 in the slot map 300 to which the reception slot 301 has been allocated. For example, the AIS transmission slot management unit 230 may allocate the AIS transmission slot 302 to empty slots #1, #10, and #19 in which no collision occurs with the slots #5, #6, #15, and #16 as the previously allocated reception slots 301.

Also, in the slot map 300 to which the reception slot 301 and the AIS transmission slot 302 have been allocated, the ASM transmission slot management unit 240 may allocate the next ASM transmission slot 303 to an empty slot in which no collision occurs with the previously allocated slots. For example, the ASM transmission slot management unit 240 may allocate the next ASM transmission slot 303 to slots #2, #3, #13, and #14, which are empty slots in which no collision occurs with the slots #5, #6, #15, and #16 as previously allocated reception slots 301 and the slots #1, #10, and #19 as previously allocated AIS transmission slots 302.

Thereafter, in the slot map 300 to which the reception slot 301, the AIS transmission slot 302, and the ASM transmission slot 303 have been allocated, the VDE transmission slot management unit 250 may allocate a next VDE transmission slot 304 to an empty slot in which no collision occurs with the previously allocated slots. For example, the VDE transmission slot management unit 250 may allocate the next VDE transmission slot 304 to empty slots #7 and #21 in which no collision occurs with the slots #5, #6, #15, and #16 as previously allocated reception slots 301, the slots #1, #10, and #19 as the previously allocated AIS transmission slots 302, and the slots #2, #3, #13, and #14 as the previously allocated ASM transmission slots 303.

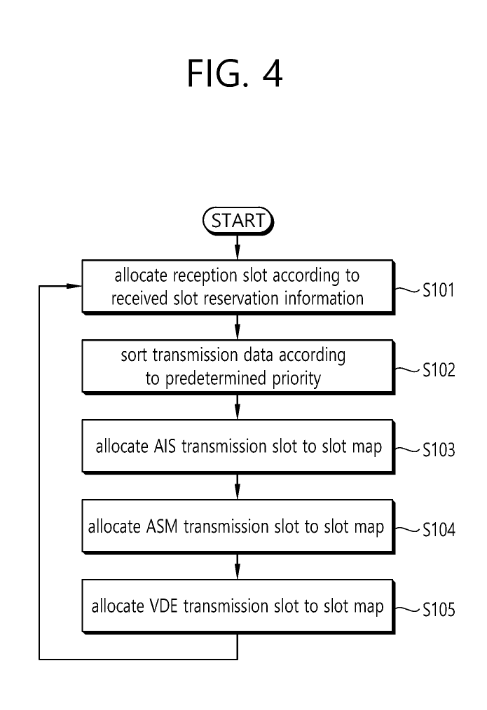

FIG. 4 is a flowchart illustrating a transmission/reception slot management method performed by a transmission/reception slot management apparatus in a VHF data exchange system for a ship according to an embodiment of the present invention.

In FIG. 4, a procedure for allocating a reception slot and a transmission slot to a slot map for the single antenna 110 for transmission/reception according to an embodiment of the present invention is illustrated.

In step S101, the transmission/reception slot management apparatus 200 allocates a reception slot according to slot reservation information received from another ship station or a BS to a slot map for transmitting and receiving data through the transmission/reception single antenna 110. Here, when power of the transmission/reception slot management apparatus 200 is turned on, the transmission/reception slot management apparatus 200 may receive slot reservation information of a neighboring ship and a BS during an initial time period (e.g., 1 minute) and allocate a reception slot to the slot map.

In step S102, the transmission/reception slot management apparatus 200 sorts transmission data to be transmitted to the other ship station or the BS according to a predetermined priority. Here, the transmission/reception slot management apparatus 200 may receive a user data list of a user (ship's mate (navigator)) received through a human machine interface (HMI) and sort the data according to priority previously determined for data transmission.

In step S103, the transmission/reception slot management apparatus 200 allocates an AIS transmission slot for transmitting AIS data, among the sorted transmission data, to the slot map. Here, the transmission/reception slot management apparatus 200 first allocates an

AIS transmission slot for transmitting a position message of the own ship to the slot map, before the other AIS transmission slots. The transmission/reception slot management apparatus 200 allocates AIS transmission slots for transmitting a position AIS message, AIS control information, AIS messages #12, #14, #6, and #8 among the AIS messages, and adjusts the same.

In step S104, the transmission/reception slot management apparatus 200 allocates an ASM transmission slot for transmitting ASM data, among the sorted transmission data, to the slot map. Here, the transmission/reception slot management apparatus 200 performs allocation and adjustment on the ASM transmission slot for ASM data transmission.

In step S105, the transmission/reception slot management apparatus 200 allocates a VDE transmission slot for transmitting VDE data, among the sorted transmission data, to the slot map. Here, the transmission/reception slot management apparatus 200 allocates the VDE transmission slot for transmission of VDE data to complete one routine. For example, the corresponding routine may be performed once at every 10 seconds and six times per minute.

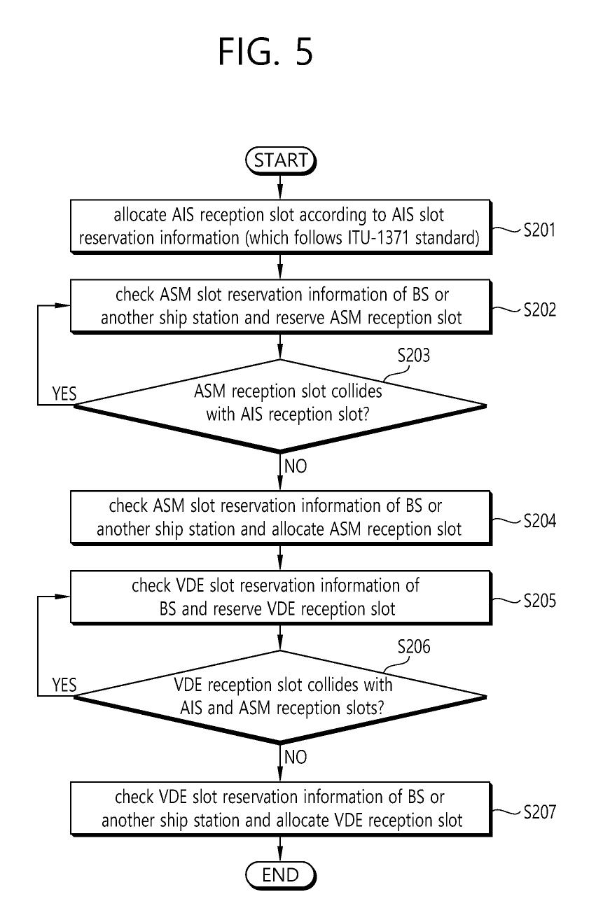

FIG. 5 is a flowchart illustrating a process of reserving a reception slot using slot reservation information in a transmission/reception slot management method according to an embodiment of the present invention.

In step S201, the transmission/reception slot management apparatus 200 performs a process of allocating an AIS reception slot according to AIS slot reservation information. The transmission/reception slot management apparatus 200 reserves the AIS reception slot so as to receive data of a neighboring ship and a BS on the basis of slot reservation information received for the first one minute. Here, the slot reservation information indicates AIS slot reservation information received through the AIS (which follows the ITU-1371 standard).

In step S202, the transmission/reception slot management apparatus 200 checks the ASM slot reservation information of the BS or another ship station and reserves an ASM reception slot of the BS for receiving ASM data from the BS or the other ship station.

In step S203, the transmission/reception slot management apparatus 200 determines whether the ASM reception slot of the BS or the other ship station collides with the previously allocated AIS reception slot.

If the ASM reception slot of the BS or the other ship station collides with the previously allocated AIS reception slot as a result of the determination in step S203, the transmission/reception slot management apparatus 200 returns to step S202 to reserve the ASM reception slot of the BS again.

In step S204, if the ASM reception slot of the BS or the other ship station does not collide with the previously allocated AIS reception slot as the result of the checking (S203), the transmission/reception slot management apparatus 200 checks the ASM slot reservation information of the BS or the other ship station and allocates the ASM reception slot of the other ship station for receiving ASM data from the BS or the other ship station.

In step S205, the transmission/reception slot management apparatus 200 checks VDE slot reservation information of the BS or another ship station and reserves a VDE reception slot of the BS or the other ship station for receiving VDE data from the BS or the other ship station.

In step S206, the transmission/reception slot management apparatus 200 determines whether the VDE reception slot of the BS or the other ship station collides with the previously allocated AIS reception slot and the ASM reception slot.

If the VDE reception slot of the BS or the other ship station collides with the previously allocated AIS reception slot and the ASM reception slot as a result of the determination in step S206, the transmission/reception slot management apparatus 200 returns to step S205 to reserve the VDE reception slot of the BS or the other ship station again.

In step S207, if the VDE reception slot of the BS or the other ship station does not collide with the previously allocated AIS reception slot and the ASM reception slot as a result of the determination in step S206, the transmission/reception slot management apparatus 200 checks VDE slot reservation information of the BS or the other ship station and allocates the VDE reception slot of the BS or the other ship station for receiving the VDE data from the BS or the other ship station.

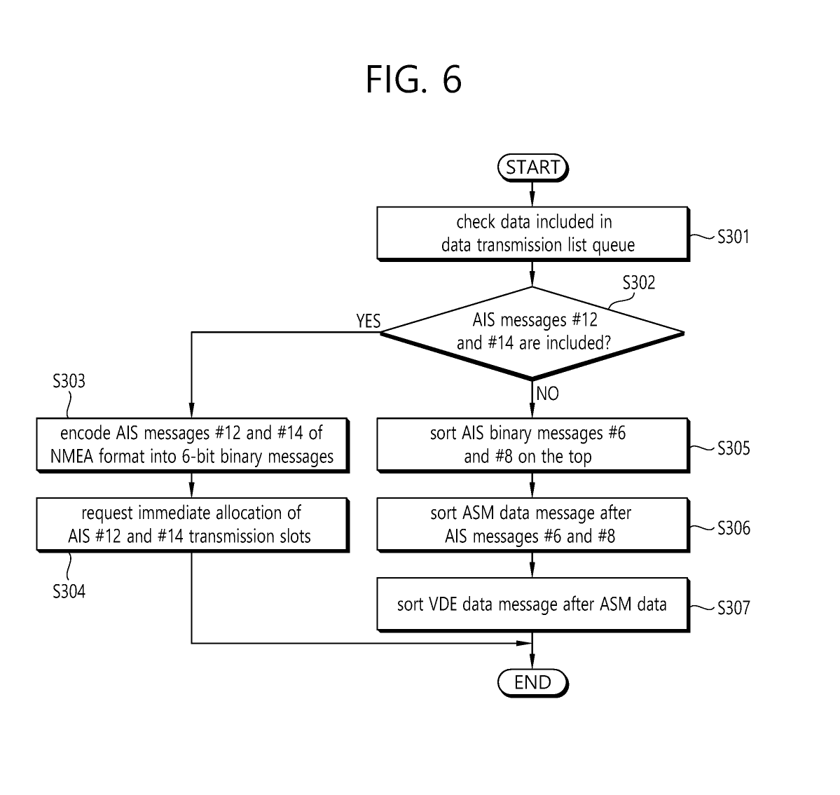

FIG. 6 is a flowchart illustrating a process of checking priority of user data and sorting message in a transmission/reception slot management method according to an embodiment of the present invention.

When the user (ship's navigator) wants to transmit user data to the surroundings via the VDES 100 for a ship, the transmission/reception slot management apparatus 200 sorts user data according to a predetermined priority. Here, when the user transmits the user data, the user data is temporarily stored in a data transmission list queue provided in the transmission/reception slot management apparatus 200 through a human machine interface (HMI (PI)) port.

As illustrated in FIG. 6, the case where AIS messages #12, #14, #6, and #8, ASM data, and VDE data are included in the stored user data will be described as an example.

In step S301, the transmission/reception slot management apparatus 200 checks data included in the data transmission list queue thereof.

In step S302, the transmission/reception slot management apparatus 200 determines whether AIS messages #12 and #14 are included in the data transmission list queue thereof. Here, the AIS messages #12 and #14 are safety-related safety message, which have higher priority than general AIS messages.

In step S303, if the AIS messages #12 and #14 are included in the data transmission list queue as a result of the determination in step S302, the transmission/reception slot management apparatus 200 encodes the AIS messages #12 and #14 in a NMEA format into 6-bit binary messages.

In step S304, the transmission/reception slot management apparatus 200 immediately requests allocation of the AIS transmission slots #12 and #14 for transmitting the AIS messages #12 and #14 encoded into the binary messages. That is, the messages #12 and #14 having higher priority, among the AIS messages are to be transmitted immediately, and if such messages are included in the data transmission list queue, the transmission/reception slot management apparatus 200 immediately converts the messages into 6-bit binary data and transmits the same.

Meanwhile, in step S305, if the AIS messages #12 and #14 are not included in the data transmission list queue as the result of the determination step S302, the transmission/reception slot management apparatus 200 sorts the AIS binary messages #6 and #8 on the top.

In step S306, the transmission/reception slot management apparatus 200 sorts the ASM data after the AIS binary messages #6 and #8.

Thereafter, in step S307, the transmission/reception slot management apparatus 200 sorts the VDE data after the ASM data.

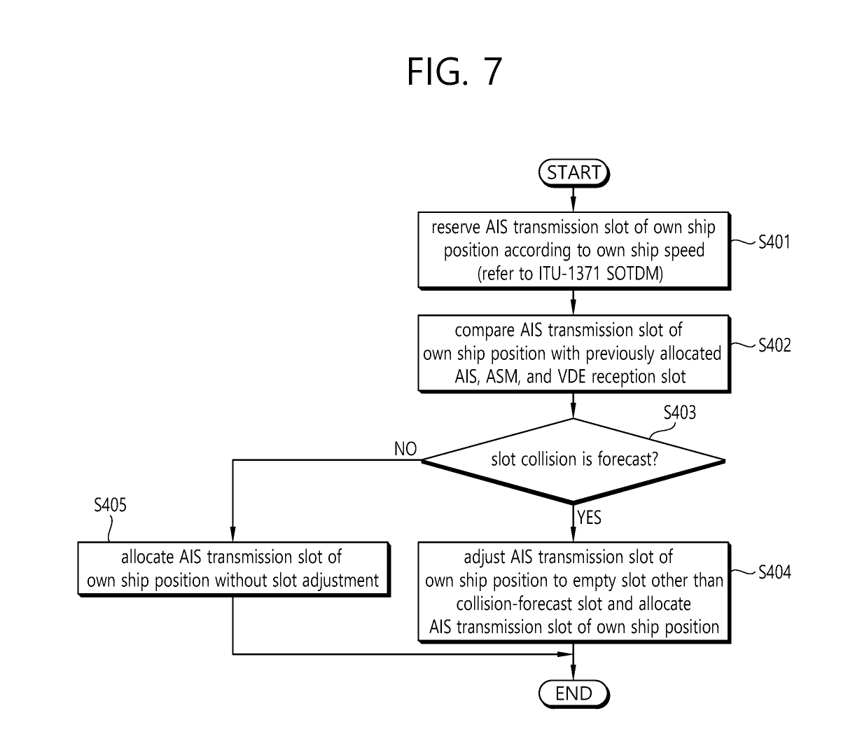

FIG. 7 is a flowchart illustrating a process of allocating a position automatic identification system (AIS) transmission slot in a transmission/reception slot management method according to an embodiment of the present invention.

As illustrated in FIG. 7, in step S401, the transmission/reception slot management apparatus 200 generates a position message of the own ship with reference to speed information of the own ship, and reserves an AIS transmission slot for transmitting a position message of the own ship (See ITU-1371 SOTDMA).

In step S402, the transmission/reception slot management apparatus 200 compares the reserved AIS transmission slot of own ship position with the previously allocated AIS reception slot, the ASM reception slot, and the VDE reception slot.

In step S403, the transmission/reception slot management apparatus 200 determines whether a slot collision is forecast.

In step S404, if a slot collision is forecast as a result of the determination in step S403, when allocating the AIS transmission slot of own ship position, the transmission/reception slot management apparatus 200 adjusts an empty slot other than a collision-forecast slot and allocates the AIS transmission slot of own ship position to the empty slot. For example, the transmission/reception slot management apparatus 200 may adjust an empty slot very next to the collision-forecast slot and allocate the AIS transmission slot of own ship position to the empty slot.

Meanwhile, in step S405, if the slot collision is not forecast as the result of the determination in step S403, the transmission/reception slot management apparatus 200 allocates the AIS transmission slot of own ship position to the reserved transmission slot without slot adjustment.

In this manner, when allocating the AIS transmission slot of own ship position for transmitting the position message of the own ship, the transmission/reception slot management apparatus 200 searches the slot map for an empty slot other than the previously allocated AIS reception slot, the ASM reception slot, and the VDE reception slot. The transmission/reception slot management apparatus 200 may allocate the AIS transmission slot of own ship position to the searched empty slot.

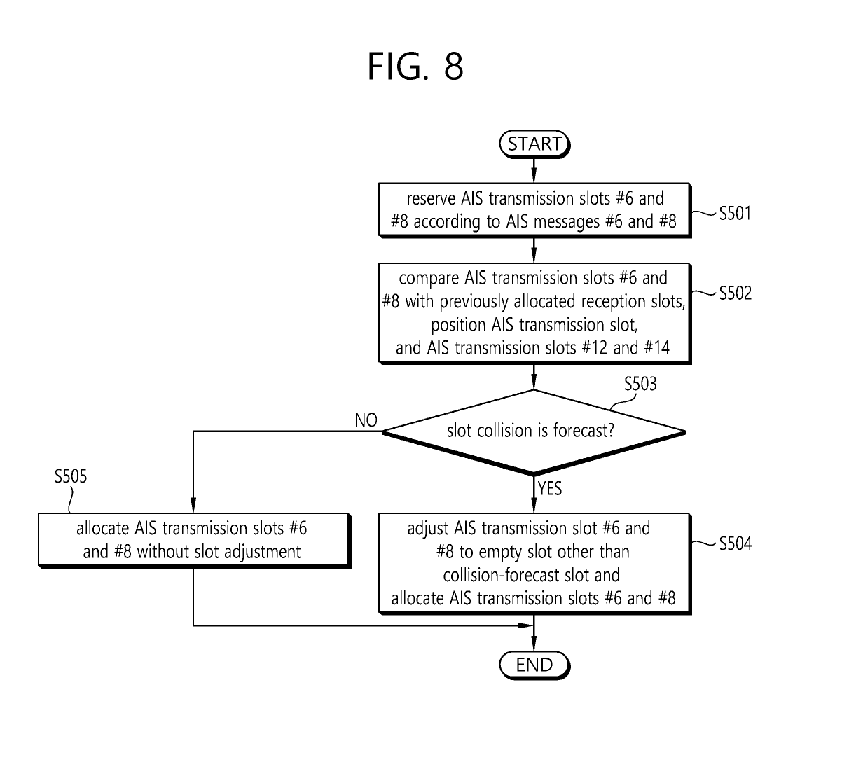

FIG. 8 is a diagram illustrating a process of allocating 6th and 8th AIS transmission slots in a transmission/reception slot management method according to an embodiment of the present invention.

FIG. 8 is a flowchart illustrating a process of allocating AIS transmission slots #6 and #8 in a transmission/reception slot management method according to an embodiment of the present invention.

When the user (ship's navigator) sends AIS messages #6 and #8 to the neighboring ship and the BS for information exchange and reporting, the transmission/reception slot management apparatus 200 searches a collision slot and adjusts next empty slots and allocates AIS transmission slots #6 and #8.

As illustrated in FIG. 8, in step S501, the transmission/reception slot management apparatus 200 reserves AIS transmission slots #6 and #8 for transmitting AIS message #6 and #8 input from the user (ship's navigator) in order to perform information exchange and reporting (See ITU-1371 RATDMA).

In step S502, the transmission/reception slot management apparatus 200 compares the reserved AIS transmission slots #6 and #8 with the previously allocated AIS reception slot, the ASM reception slot, the VDE reception slot, the position AIS transmission slot, and the AIS transmission slots #12 and #14.

In step S503, the transmission/reception slot management apparatus 200 determines whether a slot collision is forecast.

In step S504, if a slot collision is forecast as a result of the determination in step S504, when transmitting the AIS transmission slots #6 and #8, the transmission/reception slot management apparatus 200 adjusts empty slots other than the collision-forecast slot and allocates the AIS transmission slots #6 and #8. For example, the transmission/reception slot management apparatus 200 may adjust empty slots very next to the collision-forecast slot and allocate the AIS transmission slots #6 and #8.

Meanwhile, in step S505, if the slot collision is not forecast as the result of the determination in step S503, the transmission/reception slot management apparatus 200 allocates the AIS transmission slots #6 and #8 to the reserved transmission slots without performing slot adjustment.

In this manner, in case where the AIS transmission slots #6 and #8 for transmitting the AIS messages #6 and #8 are allocated, the transmission/reception slot management apparatus 200 searches the slot map for empty slots other than the previously allocated AIS reception slot, the ASM reception slot, the VDE reception slots, the position AIS transmission slot, and the AIS transmission slots #12 and #14. The transmission/reception slot management apparatus 200 may allocate the AIS transmission slots #6 and #8 to the searched empty slots.

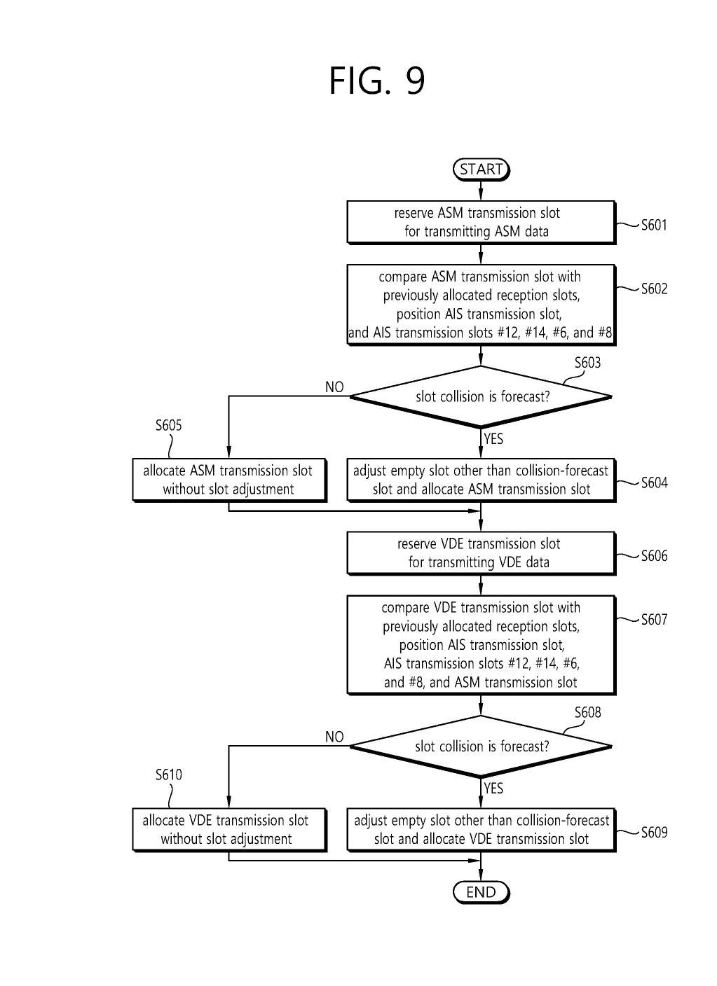

FIG. 9 is a flowchart illustrating a process of allocating application specific message (ASM) and VHF data exchange (VDE) transmission slots in a transmission/reception slot management method according to an embodiment of the present invention.

When the user (ship's navigator) sends ASM and VDE data for information exchange and reporting by a relatively large amount of data as compared with the AIS message, the transmission/reception slot management apparatus 200 searches for a collision slot, adjusts next empty slots, and sequentially reserves the ASM and VDE transmission slots.

As illustrated in FIG. 9, in step S601, for information exchange and reporting by relatively large data, the transmission/reception slot management apparatus 200 reserves an ASM transmission slot to transmit ASM data input from the user (ship's navigator).

In step S602, the transmission/reception slot management apparatus 200 compares the reserved ASM transmission slot with the previously allocated AIS reception slot, the ASM reception slot, the VDE reception slot, the position AIS transmission slot, the AIS transmission slots #12, #14, #6, and #8.

In step S 603, the transmission/reception slot management apparatus 200 determines whether a slot collision is forecast.

In step S604, if a slot collision is expected as a result of the termination in step S603, when transmitting the ASM transmission slots, the transmission/reception slot management apparatus 200 adjusts empty slots other than the collision-forecast slot and allocates the ASM transmission slots. For example, the transmission/reception slot management apparatus 200 may adjust empty slots very next to the collision-forecast slot and allocate the ASM transmission slots.

Meanwhile, in step S605, if it a slot collision is not forecast as a result of the determination in step S603, the transmission/reception slot management apparatus 200 allocates the ASM transmission slots to the reserved transmission slots without slot adjustment.

As described above, when allocating the ASM transmission slot for transmitting ASM data, the transmission/reception slot management apparatus 200 searches the slot map for an empty slot other than the previously allocated AIS reception slot, the ASM reception slot, the VDE reception slot, the position AIS transmission slot, the AIS transmission slots #12, #14, #6, and #8. The transmission/reception slot management apparatus 200 may allocate the ASM transmission slot to the searched empty slot.

Thereafter, in step S606, in order to perform information exchange and reporting by relatively large data, the transmission/reception slot management apparatus 200 reserves a VDE transmission slot for transmitting the VDE data input from the user (ship's navigator).

In step S607, the transmission/reception slot management apparatus 200 compares the reserved VDE transmission slot with the previously allocated AIS reception slot, the ASM reception slot, the VDE reception slot, the position AIS transmission slot, the AIS transmission slots #12, #14, #6, and #8, and the ASM transmission slot.

In step S608, the transmission/reception slot management apparatus 200 determines whether a slot collision is forecast.

In step S609, if a slot collision is forecast, when transmitting the VDE transmission slot, the transmission/reception slot management apparatus 200 adjusts an empty slot other than the collision-forecast slot and allocates the VDE transmission slot. For example, the transmission/reception slot management apparatus 200 may adjust an empty slot very next to the collision-forecast slot and allocate the VDE transmission slot.

Meanwhile, in step S609, if a slot collision is not forecast as a result of the determination in step S608, the transmission/reception slot management apparatus 200 allocates the VDE transmission slot to the reserved transmission slot without slot adjustment.

In this manner, when allocating a VDE transmission slot for transmitting VDE data, the transmission/reception slot management apparatus 200 searches the slot map for an empty slot other than the previously allocated AIS reception slot, the ASM reception slot, the VDE reception slot, the position AIS transmission slot, the AIS transmission slots #12, #14, #6, and #8, and ASM transmission slot. The transmission/reception slot management apparatus 200 may allocate the VDE transmission slot to the searched empty slot.

Although the present invention has been described with reference to the drawings and embodiments, it is to be understood that the scope of the present invention is not limited by the drawings or embodiments and that the invention may be variously modified and changed without departing from the spirit and scope of the invention.

Embodiments of the present invention may effectively manage slots for transmitting and receiving AIS, ASM, and/or VDE data in a VHF data exchange system (VDES) using a single antenna.

What is claimed is:

1. A transmission/reception slot management apparatus used for a VHF data exchange system (VDES) for a ship, the transmission/reception slot management apparatus comprising:
a slot integrated management unit managing a slot map for transmitting and receiving data through a single antenna for transmission/reception;
a plurality of transmission slot management units allocating, to the slot map, a reception slot according to a slot reservation information received from another ship station or a base station (BS); and
a data transmission controller sorting transmission data to be transmitted to the other ship station or the base station(BS) according to predetermined priority,
wherein the plurality of transmission slot management units sequentially allocate, to the slot map, the sorted transmission data according to the predetermined priority.

2. The transmission/reception slot management apparatus of claim 1, wherein the plurality of transmission slot management unit includes:
an automatic identification system (AIS) transmission slot management unit allocating, to the slot map, an AIS transmission slot for transmitting an AIS message among the sorted transmission data;
an application specific message (ASM) transmission slot management unit allocating, to the slot map, an ASM transmission slot for transmitting an application specific message (ASM) data among the sorted transmission data; and
a VHF data exchange (VDE) transmission slot management unit allocating, to the slot map, a VDE transmission slot for transmitting VDE data among the sorted transmission data,
wherein after reception slots according to slot reservation information received from another ship station or the BS are each allocated to the slot map, the AIS transmission slot, the ASM transmission slot, and the VDE transmission slot are allocated to the slot map, and the AIS transmission slot management unit first allocates, to the slot map, an AIS transmission slot for transmitting a position message of an own ship before any other AIS transmission slots.

3. The transmission/reception slot management apparatus of claim 1, wherein the plurality of transmission slot management units each allocate a reception slot according to each slot reservation information for receiving an AIS message, ASM data, and VDE data from the other ship station or the base station(BS).

4. The transmission/reception slot management apparatus of claim 1, wherein the data transmission controller sorts the transmission data in order of an AIS message, ASM data, and VDE data.

5. The transmission/reception slot management apparatus of claim 1, wherein the plurality of transmission slot management units first allocate an AIS transmission slot for transmitting a safety message related to ship safety among the transmission data before the other AIS transmission slots excluding an AIS transmission slot for transmitting a position message.

6. The transmission/reception slot management apparatus of claim 1, wherein the plurality of transmission slot management units allocate an AIS transmission slot to an empty slot in which a collision does not occur with the reception slot in the slot map to which the reception slot has been allocated.

7. The transmission/reception slot management apparatus of claim 6, wherein the plurality of transmission slot management units allocate an ASM transmission slot to an empty slot in which a collision does not occur with previously allocated slots in the slot map to which the reception slot and the AIS transmission slot have been allocated.

8. The transmission/reception slot management apparatus of claim 7, wherein the plurality of transmission slot management units allocate a VDE transmission slot to an empty slot in which a collision does not occur with previously allocated slots in the slot map to which the reception slot, the AIS transmission slot, and the ASM transmission slot have been allocated.

9. A transmission/reception slot management method performed by a transmission/reception slot management apparatus of a VHF data exchange system (VDES) for a ship, the transmission/reception slot management method comprising:
allocating, to a slot map for transmitting and receiving data through a single antenna for transmission/reception, a reception slot according to slot reservation information received from another ship station or a base station(BS);
sorting transmission data to be transmitted to the other ship station or the base station(BS) according to a predetermined priority; and
sequentially allocating, to the slot map, the sorted transmission data according to the predetermined priority.

10. The transmission/reception slot management method of claim 9, wherein the sequentially allocating of the sorted transmission data includes:
allocating, to the slot map, an AIS transmission slot for transmitting automatic identification system (AIS) data among the sorted transmission data;
allocating, to the slot map, an ASM transmission slot for transmitting an application specific message (ASM) data among the sorted transmission data; and
allocating, to the slot map, a VHF data exchange (VDE) transmission slot for transmitting VDE data among the sorted transmission data,
wherein, in the allocating of the AIS transmission slot, an AIS transmission slot for transmitting a position message of an own ship is first allocated to the slot map before any other AIS transmission slots.

11. The transmission/reception slot management method of claim 9, wherein, in the allocating of a reception slot, the reception slot is allocated according to each slot reservation information for receiving an AIS message, ASM data, and VDE data from the other ship station or the BS.

12. The transmission/reception slot management method of claim 9, wherein, in the sorting of transmission data, the transmission data is sorted in order of an AIS message, ASM data, and VDE data.

13. The transmission/reception slot management method of claim 9, wherein, in the sequentially allocating of the sorted transmission data, an AIS transmission slot for transmitting a safety message related to ship safety among the transmission data is first allocated before the other AIS transmission slots excluding an AIS transmission slot for transmitting a position message.

14. The transmission/reception slot management method of claim 9, wherein, in the sequentially allocating of the sorted transmission data, an AIS transmission slot is allocated to an empty slot in which a collision does not occur with the reception slot in the slot map to which the reception slot has been allocated.

15. The transmission/reception slot management method of claim 14, wherein, in the sequentially allocating of the sorted transmission data, an ASM transmission slot is allocated to an empty slot in which a collision does not occur with previously allocated slots in the slot map to which the reception slot and the AIS transmission slot have been allocated.

16. The transmission/reception slot management method of claim 15, wherein, in the sequentially allocating of the sorted transmission data, a VDE transmission slot is allocated to an empty slot in which a collision does not occur with previously allocated slots in the slot map to which the reception slot, the AIS transmission slot, and the ASM transmission slot have been allocated.

17. A VHF data exchange system (VDES) for a ship, the VHF data exchange system(VDES) comprising:
a single antenna for transmission/reception for transmitting and receiving a communication signal to and from another ship station or a base station (BS);
a switch switching a path of the single antenna for transmission/reception to a transmitter or a receiver;
a transmitter transmitting data via the single antenna for transmission/reception;
a receiver receiving data via the single antenna for transmission/reception; and
a processor managing a slot map for transmitting and receiving data via the single antenna for transmission/reception and controlling the transmitter and the receiver on the basis of the slot map,
wherein the processor allocates a reception slot according to slot reservation information received through the receiver, sorts transmission data to be transmitted to another ship or a base station(BS) according to a predetermined priority, and sequentially allocates, to the slot map, the sorted transmission data according to the predetermined priority.

18. The VHF data exchange system(VDES) of claim 17, wherein the processor sequentially allocates, to the slot map, an AIS transmission slot for transmitting an AIS message, an ASM transmission slot for transmitting ASM data, and a VDE transmission slot for transmitting VDE data among the sorted transmission data, and here, the processor first allocates an AIS transmission slot for transmitting a position information of an own ship before any other AIS transmission slots.

19. The VHF data exchange system(VDES) of claim 17, further comprising:
a filter extracting a channel signal of at least one of an AIS channel signal, an ASM channel signal, and a VDE channel signal through filtering of a signal received through the switch, and delivering the extracted channel signal to the receiver; and
a global positioning system (GPS) receiver receiving a global positioning system(GPS) signal through a global positioning system(GPS) antenna and delivering the received global positioning system(GPS) signal to the processor.
